(19) United States
(12) Patent Application Publication
(10) Pub. No.: US 2025/0361134 A1
(43) Pub. Date: Nov. 27, 2025

(54) LID ASSIST TOOL

(71) Applicant: Parker Roth, Naples, FL (US)

(72) Inventor: Parker Roth, Naples, FL (US)

(21) Appl. No.: 18/675,002

(22) Filed: May 27, 2024

(51) Int. Cl. B67B 7/18; A47G 23/02

(52) U.S. Cl. CPC B67B 7/18; A47G 23/0216; B67B 2007/188

(57) ABSTRACT

The present invention is a Lid Assist Tool designed to enhance the ease of opening and closing twist-off lids on beverage containers. This tool attaches to the outside of the lid, utilizing a specific geometry to improve the user's grip and leverage. It is particularly beneficial for individuals with limited hand strength, dexterity issues, or when dealing with slippery or stuck lids. By enhancing the user's ability to apply torque with minimal effort, the Lid Assist Tool offers a practical and convenient solution to common challenges associated with twist-off lids.

### BACKGROUND

Traditional twist-on lids for beverage containers, such as those used by popular brands like Yeti or Stanley, often present challenges for users. These lids can become difficult to open due to several factors, including pressure differentials caused by temperature changes, residue build-up around the threads, and insufficient grip strength from the user. These difficulties are particularly pronounced for individuals with limited hand strength, arthritis, or other dexterity issues.

Current solutions to this problem typically involve external tools designed to increase grip or torque. However, these tools are not always convenient to carry, may pose safety risks, and do not provide a tailored solution for specific lid types and sizes. There is a clear need for an integrated solution that enhances the user's ability to open and close lids effortlessly, without requiring separate tools.

Additionally, there is a need for a retrofit solution that allows existing lids to be equipped with such a leverage tool. This would enable users to upgrade their current beverage containers, ensuring they can easily open and close lids without difficulty. The Lid Assist Tool addresses these needs by providing a built-in leverage mechanism that can be easily integrated into or attached to compatible lids, thereby facilitating easier and safer operation.

### SUMMARY OF THE INVENTION

The present invention is a Lid Assist Tool designed to attach to existing twist-off lids of beverage containers. This tool couples to the outside of the lid and provides a geometry that enhances the user's ability to grip and twist the lid open or closed. It is particularly useful for individuals with small hands, weak grip strength, dexterity issues, or when the lid is slippery or stuck. The Lid Assist Tool improves the user's ability to manipulate the lid with minimal effort, offering a practical and convenient solution for common difficulties encountered with twist-off lids.

### DESCRIPTION OF THE DRAWINGS

FIG. 1 is a prospective view of an embodiment of a lid assist tool.

FIG. 2 is a prospective view of an embodiment of a lid assist tool not coupled to a lid on a beverage container.

FIG. 3 is a prospective view of an embodiment of a lid assist tool coupled to a lid on a beverage container.

FIG. 4 is a prospective view of an embodiment of a lid assist tool coupled to a lid off of a beverage container.

FIG. 5 is a prospective view of an embodiment of a lid assist tool coupled to a lid on a beverage container.

FIG. 6 is a prospective view of an embodiment of a lid assist tool coupled to a lid on a beverage container.

### DETAILED DESCRIPTION

A few of the preferred embodiments have been illustrated and described in detail. It is understood, however, that numerous modifications can be made without departing from the invention's scope as claimed. Those skilled in the art will recognize that many variations and substitutions may be made, qualifying as equivalents under the patent claims. The specific embodiments described herein are intended only to exemplify the invention and should not be seen as limiting its spirit or scope.

In the figures, not every element is assigned a reference number. Directional terms such as “forward,” “rearward,” “upper,” “lower,” “bottom,” “top,” and “side” are used to describe the orientation of the components as depicted in the drawings. Those skilled in the art will understand that these orientations may vary during actual use of the invention and are not intended to be limiting.

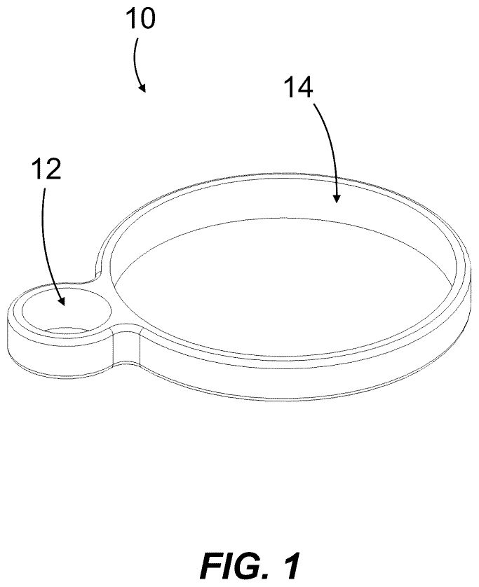

FIG. 1 illustrates a perspective view of an embodiment of the lid assist tool 10. This embodiment includes two primary components: a coupling element 14 and a grabbing element 12. The coupling element 14 is an elastic band designed to secure around the exterior of the lid 20, providing a firm grip. The grabbing element 12 in this embodiment is a ring, through which the user can insert a finger to gain a solid hold. When the user pulls on the ring, torque is transferred through the grabbing element 12 to the coupling element 14, enabling the user to easily twist off, loosen, or twist on the lid 20. This design is particularly beneficial for individuals with small hands, offering a cost-effective and efficient solution for existing lids 20 on the market. The elastic band can be manufactured in various textures, colors, and patterns, allowing for personalization of the lid 20 and beverage container 22. Additionally, the design may include functionalities such as a straw holder or a loop for keys, further aiding in the opening and closing of the lid 20 and serving as an attachment point for various accessories.

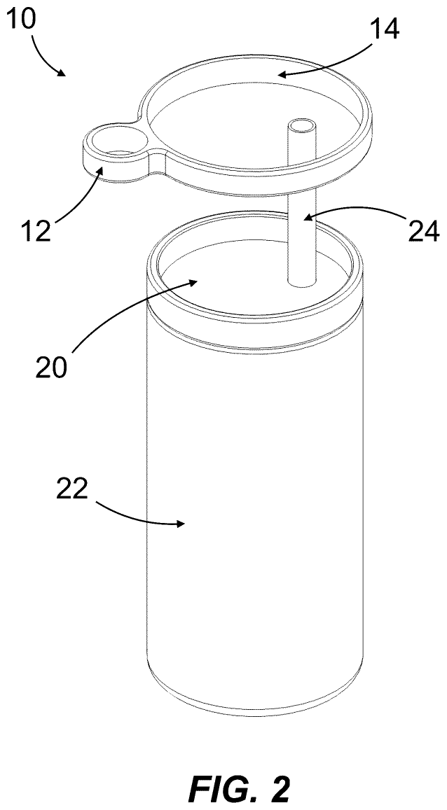

FIG. 2 illustrates a perspective view of an embodiment of the lid assist tool 10 that is not coupled to a lid 20 on a beverage container 22. This pre-installation view demonstrates that the lid assist tool 10 is a separate device designed to attach to an existing lid 20. This configuration highlights its versatility and ease of use, as it can be retrofitted onto various types of lids 20 without requiring permanent modifications to the beverage container 22. The tool's design allows users to quickly and effectively attach it to their lids 20, providing immediate assistance for opening and closing.

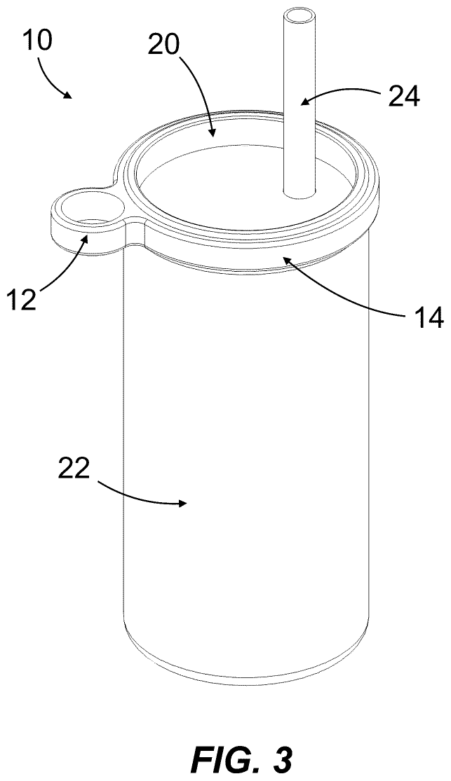

FIG. 3 illustrates a perspective view of an embodiment of the lid assist tool 10 coupled to a lid 20 on a beverage container 22. This figure shows the device from FIG. 2 now installed on the lid 20, ready for use. The coupling element 14 securely grips the circumference of the lid 20, while the grabbing element 12, such as the ring, is positioned for the user to apply torque. This setup demonstrates how the lid assist tool 10, once attached, facilitates the easy opening and closing of the lid 20 by enhancing the user's grip and leverage. The installation process is straightforward, making it convenient for users to retrofit their existing beverage containers 22 with this tool.

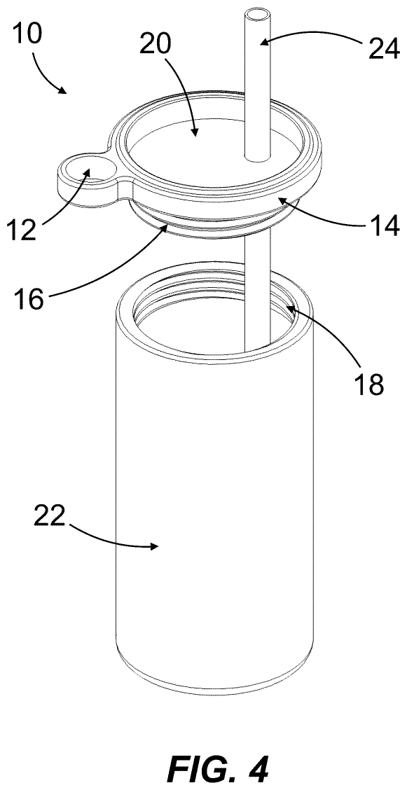

FIG. 4 illustrates a perspective view of an embodiment of the lid assist tool 10 coupled to a lid 20 that has been removed from a beverage container 22. This figure demonstrates the embodiment from FIG. 3 after it has been used to take off the lid 20. The lid assist tool 10 remains attached to the lid 20 even when it is removed from the beverage container 22. This configuration ensures that the tool stays with the lid 20, making it ready for the next use and preventing it from getting misplaced. The consistent attachment to the lid 20 also highlights the tool's convenience and efficiency in aiding the opening and closing process.

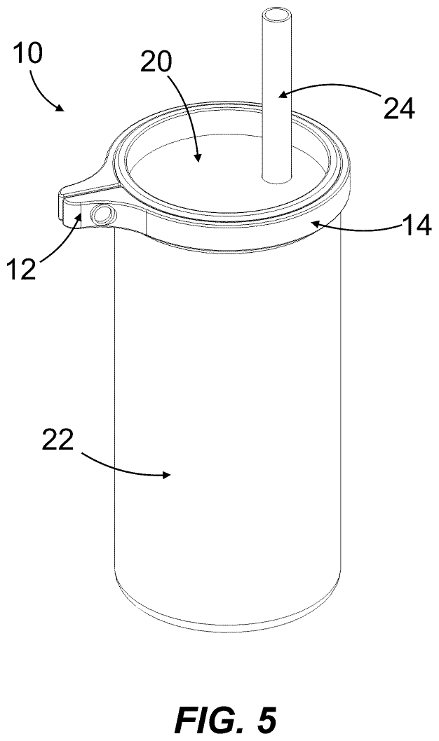

FIG. 5 illustrates a perspective view of an embodiment of the lid assist tool 10 that, unlike the prior embodiments, utilizes clamping forces to secure itself to the outside of the lid 20. This figure serves to illustrate how different methods of the coupling element 14 can be implemented. In this embodiment, the coupling element 14 comprises a clamping mechanism that grips the lid 20 firmly, providing a secure attachment.

Additionally, instead of a ring for the grabbing element 12, this embodiment features a hand stop. The hand stop functions as a small lever on the outside of the lid 20, adding torque and preventing the hand from slipping. This alternative approach to the grabbing element 12 demonstrates the versatility of the lid assist tool 10 in achieving the desired leverage and grip through different designs. The hand stop ensures a firm hold and ease of use, enhancing the user's ability to open and close the lid 20 efficiently.

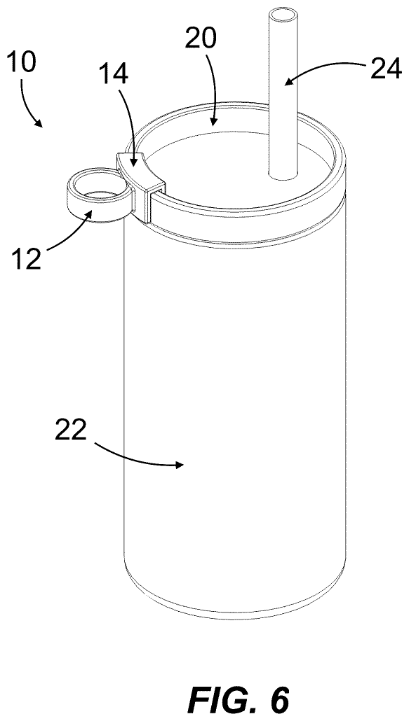

FIG. 6 illustrates a perspective view of an embodiment of the lid assist tool 10 that differs from the prior embodiments in its coupling mechanism. In this embodiment, the coupling element 14 grips only a portion of the outside of the lid 20, rather than wrapping around the entire lid 20 as in previous designs. This partial grip provides an effective means of attachment while reducing material usage and potentially simplifying the design.

The grabbing element 12 in this embodiment is a ring, similar to the previous embodiment. Although the ring is solid in this embodiment, it can be made from various materials such as fabric, string, or other flexible materials or shapes that allow for easy grabbing to apply torque to the coupling element 14 that grips the outside of the lid 20. This flexibility in the design of the grabbing element 12 ensures that the lid assist tool 10 can be adapted to suit different user preferences and needs, while still enhancing the user's ability to open and close the lid 20 effectively.

The beverage container 22 and lid 20 in the embodiments may include features such as a straw 24. The scope of this invention applies to all variations of beverage containers 22 and lids 20 with different characteristics, including but not limited to those with straws, no straws, stoppers, no stoppers, drinking passages, and no drinking passages. The lid assist tool 10 is designed to facilitate the opening and closing of any lid 20 that requires torque, regardless of these variations. This ensures the tool's broad applicability across a wide range of beverage containers 22, making it a versatile solution for users with diverse needs and preferences.

What is claimed is:

1. A lid assist tool for a beverage lid, comprising;
A coupling element designed to attach to the lid; and,
A grabbing element configured to be engaged by a user,
Wherein the beverage lid requires torque to be disconnected from the beverage container.

2. The lid assist tool of claim 1, wherein the coupling element is an elastic band that wraps around the outside of the lid.

3. The lid assist tool of claim 1, wherein the coupling element is a clamp that securely grips the lid.

4. The lid assist tool of claim 1, wherein the grabbing element is a ring through which the user can insert a finger.

5. The lid assist tool of claim 1, wherein the grabbing element is a hand stop designed to prevent slipping and provide leverage.

6. The lid assist tool of claim 1, wherein the grabbing element consist of multiple hand stops.

7. The lid assist tool of claim 1, wherein the tool is textured to enhance grip.

8. The lid assist tool of claim 1, wherein the tool is available in various colors and patterns.

9. The lid assist tool of claim 1, wherein the coupling element partially grips the lid.

10. The lid assist tool of claim 1, wherein the grabbing element is made from fabric.

11. The lid assist tool of claim 1, wherein the grabbing element is made from string.

12. The lid assist tool of claim 1, wherein the grabbing element is made from textiles.

13. The lid assist tool of claim 1, wherein tool is made at least partially of metal.

14. The lid assist tool of claim 1, wherein tool is made at least partially of plastic.

15. The lid assist tool of claim 1, wherein the coupling element is adjustable to fit different lid sizes.

16. The lid assist tool of claim 1, wherein the coupling element includes a quick-release mechanism.

17. The lid assist tool of claim 1, wherein the grabbing element is ergonomically designed for comfort.

18. The lid assist tool of claim 1, wherein the tool is made from a material that is resistant to high and low temperatures.

19. The lid assist tool of claim 1, wherein the tool is dishwasher safe.

20. The lid assist tool of claim 1, wherein the tool is designed to hold drink ware items.
